(19) United States
(12) Patent Application Publication
(10) Pub. No.: US 2005/0246884 A1
(43) Pub. Date: Nov. 10, 2005

(54) Friction welding structure for striking plate of golf club head and method therefor

(76) Inventor: Chan-Tung Chen, Kaohsiung (TW)

Correspondence Address: BIRCH STEWART KOLASCH & BIRCH, PO BOX 747, FALLS CHURCH, VA, 22040-0747, US

(21) Appl. No.: 10/787,176

(22) Filed: Feb. 27, 2004

(51) Int. Cl. B23P 11/00; A63B 53/04

(52) U.S. Cl. 29/525; 473/342

(57) ABSTRACT

A method for manufacturing a golf club head includes providing a body having an opening delimited by an inclined surface, providing a striking plate with an inclined surface, engaging the inclined surface of the striking plate with the inclined surface of the body, applying a force to the striking plate to tightly embed the striking plate in the opening of the body, moving a rotating pin along an engaging area between the striking plate and the body to proceed with friction welding, and surface finishing the engaging area between the striking plate and the body. For carrying out the method, a friction welding structure for a golf club head includes a body having an opening delimited by an inclined perimeter surface and a striking plate having an inclined perimeter surface.

### BACKGROUND OF THE INVENTION

1. Field of the Invention

The present invention relates to a friction welding structure for a striking plate of a golf club head and a method therefor. In particular, the present invention relates to a structure allowing the striking plate to be engaged with a body of the golf club head by friction welding. The present invention also relates to a method for frictionally welding the striking plate to the body of the golf club head.

2. Description of Related Art

Current golf club heads are made of composite materials. In particular, the body and the striking plate of a golf club head are made from different materials. For example, the body can be made from 17-4PH stainless steel, and the striking plate can be made from 6A1-4V titanium alloy, thereby providing a golf club head having a body of high strength and a striking plate of excellent deformability.

Although the striking effect of the golf club head is improved, it is rather difficult to obtain good bonding between different materials. The striking plate is generally engaged with the body of the golf club head by mechanical insertion, gluing, brazing, and traditional welding such as argon welding. A mark exists between the engaging area between the striking plate and the body of the golf club head when insertion is adopted, which mark often hinders transmission of the momentum from the striking plate to the golf ball. The deformability of the striking plate is adversely affected. Further, odd sound is generated as a result of mutual impact between the striking plate and the body of the golf club head. If the striking plate is engaged with the body of the golf club head by gluing, the bonding strength is not always satisfactory and thus could not be used with all kinds of golf club heads.

The whole golf club head must be heated if brazing is chosen, which affects the metal phase of the material of the golf club head, leading to weakening of the material and shortening of the life of the golf club head product. If argon welding is used, since the welding compatibility between different materials is poor, solidified cracks and welding bead cracks are generated and the mechanical properties are adversely affected after welding. The welding effect is poor. To mitigate the above drawbacks, solid-state welding is used, and the most popular one is friction stir welding.

U.S. patent application Publication No. US 2002/0187851 A1 discloses a manufacturing method for a golf club head. As illustrated in FIGS. 1A through 1C of the drawings which correspond to FIGS. 3 through 5 of U.S. patent application Publication No. US 2002/0187851 A1, the golf club head includes a body 10 and a reinforced plate 20 that are made by casting or forging, wherein a major component of the reinforced plate 20 is the same metal as that of the body 10, but the reinforced plate 20 is harder than the body 10. The reinforced plate 20 is frictionally welded to a sweet spot of the body 20, wherein the body 10 is fixed steady and the reinforced plate 20 is turned with a high rotation speed and has a vertical pressure P exerted thereon, and when the reinforced plate 20 touches the body 10, friction occurring from the rotation of the reinforced plate 20 against the fixed steady body 10 and the vertical pressure P melts interface areas of the reinforced plate 20 and the body 10, and the reinforced plate 20 is securely embedded in the body 10 and has burrs formed therearound. The burrs and the part of the reinforced plate 20 protruded from the body 10 are then removed.

Although the method disclosed in U.S. patent application Publication No. US 2002/0187851 A1 simplifies the procedure for manufacturing a golf club head and improves the bonding quality, the reinforced plate 20 (i.e., striking plate) must be circular, as the striking plate 20 must rotate relative to the body 10. Namely, non-circular striking plates cannot be used. Further, the striking area provided by the striking plate 20 is relatively small; i.e., the sweet spot of the resultant golf club head is small. Further, in a case that the friction contact area between the striking plate 20 and the body 10 is too large or an oxide layer exists in the contact area, the friction temperature cannot effectively rise. As a result, an intermetallic layer is generated during friction welding. In particular, if the welding compatibility between the material of the striking plate 10 and the material of the body 10 is insufficient, the characteristics of the intermetallic layer would adversely affect the bonding strength of the golf club head, leading to a fragile structure and/or reduction in the elastic deformability.

### OBJECTS OF THE INVENTION

An object of the present invention is to provide a structure allowing the striking plate to be engaged with a body of the golf club head by friction welding, wherein the bonding strength and bonding reliability of the golf club head is improved. The procedure for manufacturing the golf club head is improved, and the application area is wider.

Another object of the present invention is to provide a structure allowing the striking plate to be engaged with a body of the golf club head by friction welding, wherein the bonding accuracy is improved.

A further object of the present invention is to provide a method for frictionally welding the striking plate to the body of the golf club head.

### SUMMARY OF THE INVENTION

In accordance with an aspect of the present invention, a method for manufacturing a golf club head comprises providing a body having an opening delimited by an inclined surface, providing a striking plate with an inclined surface, engaging the inclined surface of the striking plate with the inclined surface of the body, applying a force to the striking plate to tightly embed the striking plate in the opening of the body, moving a rotating pin along an engaging area between the striking plate and the body to proceed with friction welding, and surface finishing the engaging area between the striking plate and the body.

Preferably, the inclined surface of the body is formed on an inner perimeter surface delimiting the opening, and the inclined surface of the striking plate is formed on an inner perimeter surface of the striking plate.

In accordance with another aspect of the invention, a friction welding structure for a golf club head comprises a body and a striking plate. The body has an opening in a front side thereof, wherein the opening is delimited by an inclined perimeter surface. The striking plate has a front face for striking a golf ball. The striking plate further includes an inclined perimeter surface.

In an embodiment of the invention, the inclined perimeter surface delimiting the opening of the body tapers inward, and the inclined perimeter surface of the striking plate tapers rearward. The inclined surface delimiting the opening of the body is planar or arcuate, and the inclined surface of the striking plate is planar or arcuate

Preferably, the inclined perimeter surface of the body has a height greater than a thickness of the striking plate.

In another embodiment of the invention, one of the inclined perimeter surface of the body and the inclined perimeter surface of the striking plate includes an annular groove, and the other of the inclined perimeter surface of the body and the inclined perimeter surface of the striking plate includes an annular flange received in the annular groove, providing accurate positioning.

In a further embodiment of the invention, the opening of the body further includes a shoulder.

An intermedia layer may be provided between the inclined perimeter surface of the body and the inclined perimeter surface of the striking plate. The intermedia layer is formed from a material selected from the group consisting of niobium, chromium, aluminum, copper, iron, zirconium, titanium, vanadium, tantalum, silver, nickel, tungsten, and alloys thereof. The intermedia layer is formed on the inclined perimeter surface of the body or the inclined perimeter surface of the striking plate by electroplating or coating.

Other objects, advantages and novel features of this invention will become more apparent from the following detailed description when taken in conjunction with the accompanying drawings.

### BRIEF DESCRIPTION OF THE DRAWINGS

FIGS. 1A through 1C are schematic sectional views illustrating a conventional method for frictionally welding a striking plate to a body of a golf club head;

FIG. 2 is a flowchart of a method for manufacturing a golf club head in accordance with the present invention;

FIG. 3 is an exploded perspective view of a golf club head in accordance with the present invention;

FIG. 4 is a perspective view illustrating friction welding of the golf club head in accordance with the present invention;

FIG. 5 is a sectional view illustrating friction welding of the golf club head in accordance with the present invention;

FIG. 6 is an enlarged view of a circled portion in FIG. 5;

FIG. 7 is a view similar to FIG. 6, illustrating a second embodiment in accordance with the present invention;

FIG. 8 is a view similar to FIG. 7, illustrating friction welding of the golf club head in accordance with the second embodiment of the present invention;

FIG. 9 is a view similar to FIG. 6, illustrating a third embodiment in accordance with the present invention; and

FIG. 10 is a view similar to FIG. 6, illustrating a fourth embodiment in accordance with the present invention.

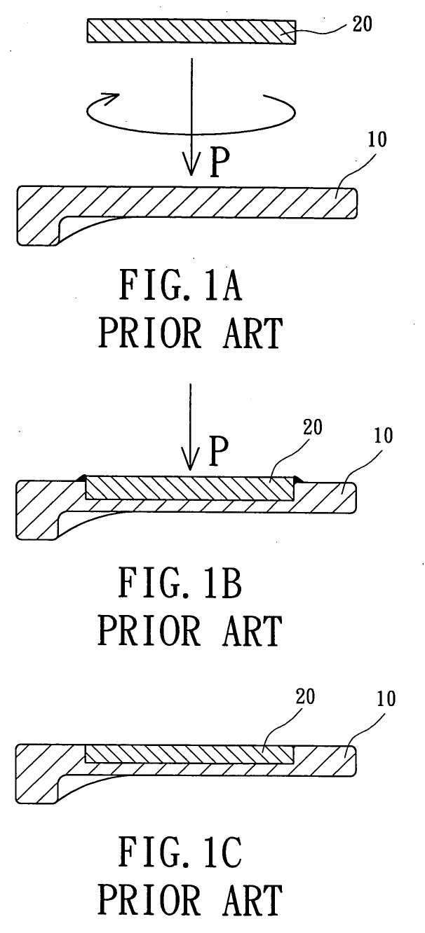

### DETAILED DESCRIPTION OF THE PREFERRED EMBODIMENTS

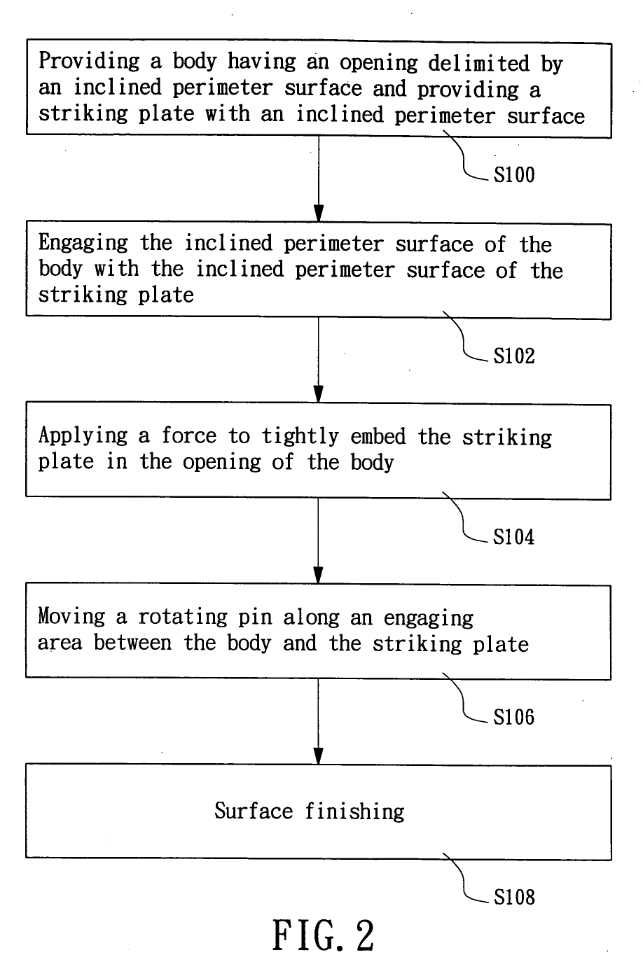

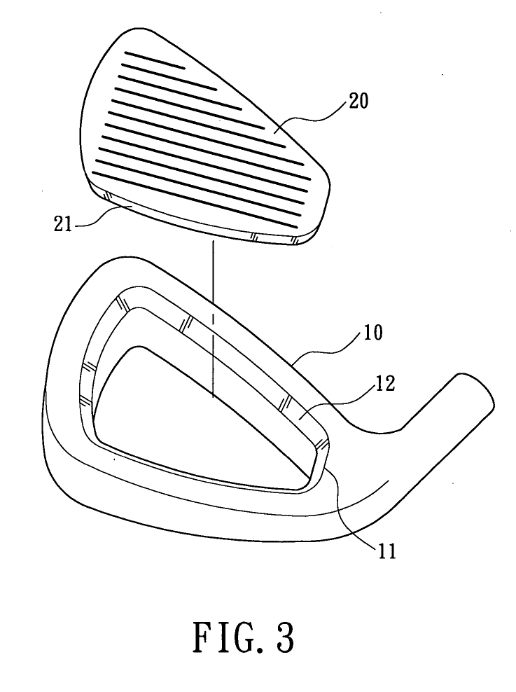

Referring to FIGS. 2 and 3, a first step of a method for manufacturing a golf club head in accordance with a first embodiment of the present invention comprises providing a body 10 having an opening 11 delimited by an inclined perimeter surface 12 and providing a striking plate 20 with an inclined perimeter surface 21 (step S100). The golf club head is an iron club comprising a body 10 with an inclined perimeter surface 12 and a striking plate 20 with an inclined perimeter surface 21. The body 10 is made from a first material selected from the group consisting of stainless steel, titanium alloy, carbon steel, low-alloy steel, cast iron, nickel-base alloy, structural steel, Fe—Mn—Al alloy, and supper alloy.

The striking plate 20 is received in the opening 11 of the body 10. Preferably, the inclined perimeter surface 12 tapers inward and is planar or arcuate. The striking plate 20 is made from a second material selected from the group consisting of stainless steel, titanium alloy, carbon steel, low-alloy steel, cast iron, nickel-base alloy, structural steel, Fe—Mn—Al alloy, and supper alloy. The striking plate 20 can be of any desired shape or thickness according to need. Preferably, the inclined perimeter surface 21 of the striking plate 20 tapers rearward and is planar or arcuate.

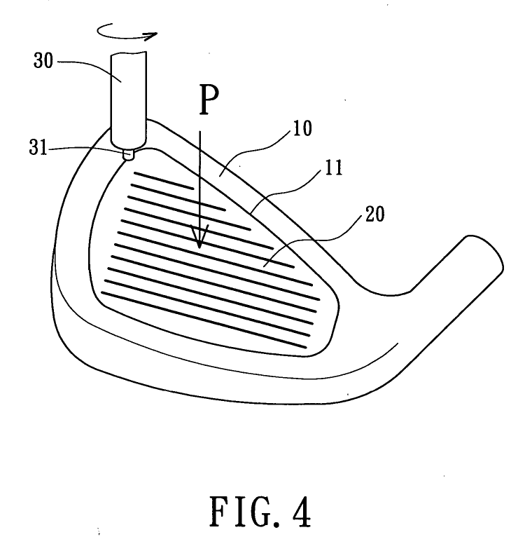

Referring to FIGS. 2 through 4, a second step of the method in accordance with the present invention is engaging the inclined perimeter surface 21 of the striking plate 20 with the inclined perimeter surface 12 of the body 10 (step S102).

Referring to FIGS. 2, 4, and 5, a third step of the method in accordance with the present invention is applying a force P to the striking plate 20 to tightly embed the striking plate 20 in the opening 11 of the body 10 (step S104). Since the height of the inclined perimeter surface 12 of the body 10 is greater than the thickness of the striking plate 20, an assembly tolerance “d” is provided while mounting the striking plate 20 into the opening 11 of the body 10. Further, the leveling of the striking plate 20 can be adjusted after the striking plate 20 is inserted into the opening 11 of the body 10 and before the friction welding procedure.

Referring to FIGS. 2, 5, and 6, a fourth step of the method in accordance with the present invention is moving a rotating pin 30 along an engaging area between the striking plate 20 and the body 10 to proceed with friction welding (step S106). The rotating pin 30 is in the form of a rotating shaft with a pressing point 31 on an end thereof. The pressing point 31 of the rotating pin 30 is made from a material selected from the group consisting of stainless steel, carbon steel, tungsten, molybdenum, and alloys thereof. The striking plate 2 is tightly embedded in the opening 11 of the body 10 under the action of the force P. Then, the rotating pin 30 presses against the engaging area (the seam) between the striking plate 20 and the body 10. Location of the rotating pin 30 may be closer to the striking plate 20 or the body 10. The rotating pin 30 is then turned at a high speed. Thus, the striking plate 20 and the body 10 generate high temperature due to friction and thus bond with each other to form an integral member. Generally, the friction temperature is controlled not to higher than the melting points of the materials of the striking plate 20 and the body 10. Thus, rotation of the rotating pin 30 would not cause melting of either of the striking plate 20 and the body 10. Accordingly, the friction welding can be completed by means of moving the rotating pin 30 along the engaging area.

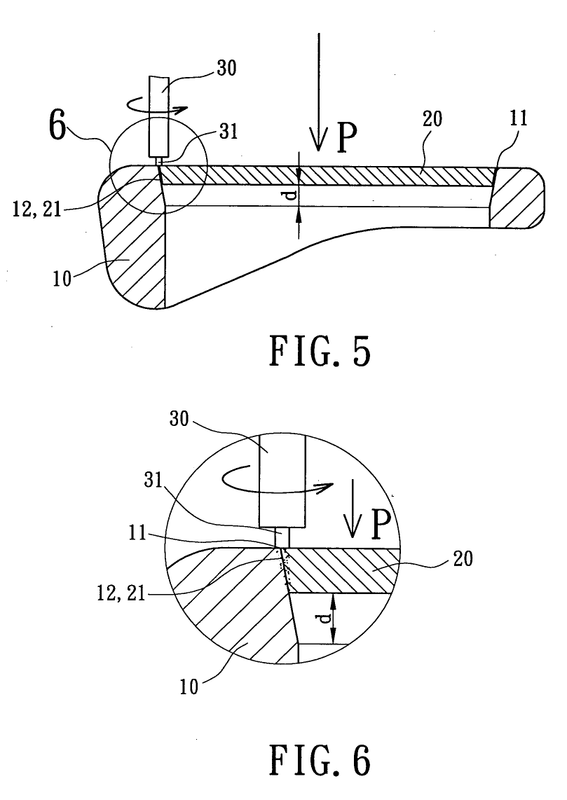

As illustrated in FIGS. 5 and 6, since the inclined perimeter surface 12 of the body 10 and the inclined perimeter surface 21 of the striking plate 20 are tightly engaged with each other, the gap therebetween is relatively small, which increases the pressing pressure and the friction welding temperature. The oxide layer existing in the engaging area can be removed by high temperature, avoiding generation of the intermetallic layer that is detrimental to the strength of the golf club head. Further, the welding area is increased while the bonding reliability and bonding strength are improved. In the mean time, since the rotating pin 30 is in contact with the engaging area at a relatively small point, the rotating force is concentrated. The friction welding temperature rises accordingly. As a result, the friction welding temperature can be accomplished at a low rotating speed and by a smaller force P. Further, since relative rotation between the striking plate 20 and the body 10 is not necessary, there is no need for a large machine and a rotating table. The procedure for manufacturing a golf club head is simplified. Further, the body 10 can be engaged with striking plates of various shapes, not limited to circular. The application area is wider.

Referring to FIGS. 2 and 6, a fifth step of the method in accordance with the present invention is surface finishing the engaging area between the striking plate 20 and the body 10, forming a golf club head product (step S108). In particular, the burrs and the part of the striking plate 20 protruding from the body 10 are removed by precision processing procedures on the engaging area, including grinding and polishing. Next, painting, application of protective paint, and packaging are carried out, providing golf club heads with aesthetically pleasing appearance and uniform specification.

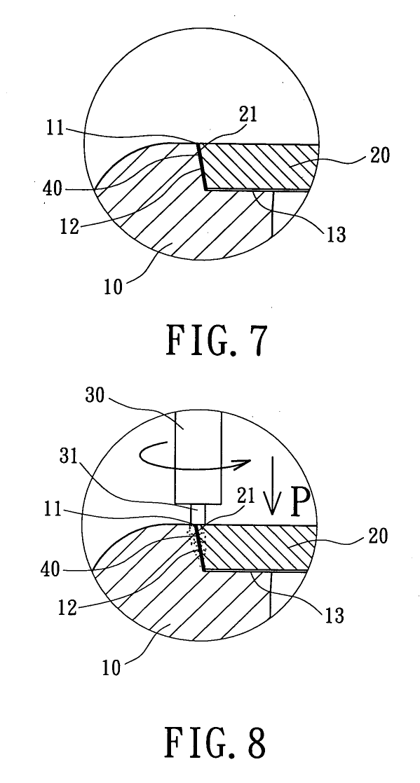

FIGS. 7 and 8 illustrate a second embodiment in accordance with the present invention, wherein the opening 11 of the body 10 includes a shoulder 13. Further, an intermedia layer 40 can be provided on the inclined perimeter surface 12 of the body 10 or the inclined perimeter surface 21 of the striking plate 20 by electroplating or coating. The intermedia layer 40 is formed from a material selected from the group consisting of niobium, chromium, aluminum, copper, iron, zirconium, titanium, vanadium, tantalum, silver, nickel, tungsten, and alloys thereof. Preferably, the metallurgical compatibility between the material of the body 10 and the material of the intermedia layer 40 is higher than that between the material of the body 10 and the material of the striking plate 20, and the metallurgical compatibility between the material of the striking plate 20 and the material of the intermedia layer 40 is higher than that between the material of the body 10 and the material of the striking plate 20. This avoids generation of the intermetallic layer between the materials of the striking plate 20, the body 10, and the intermedia layer 40.

As illustrated in FIG. 7, the intermedia layer 40 is located between the inclined perimeter surface 12 and the inclined perimeter surface 21, with the shoulder 13 stably supporting the intermedia layer 40 and the striking plate 20. As illustrated in FIG. 8, when proceeding with friction welding, with the high heat generated as a result of rotation of the rotating pin 30 and with the tight engagement between the inclined perimeter surfaces 12 and 21, the body 10, the intermedia layer 40, and the striking plate 20 are bonded together with better metallurgical compatibility in a solid state. The bonding strength and bonding reliability are further improved.

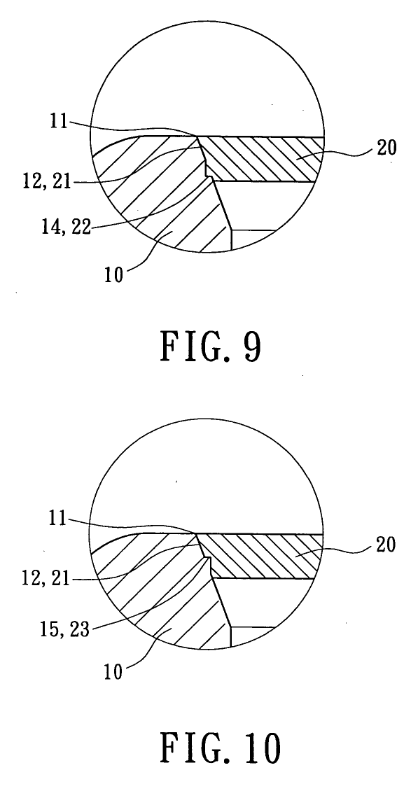

FIG. 9 illustrates a third embodiment of the present invention, wherein an annular groove 14 is defined in the inclined perimeter surface 12 of the body 10, and an annular flange 22 is formed on the inclined perimeter surface 21 of the striking plate 20. The annular flange 22 is received in the annular groove 14 to accurately positioning the striking plate 20 in the opening 11 of the body 10. The leveling of the striking plate 20 is assured.

FIG. 10 illustrates a fourth embodiment of the present invention, wherein an annular groove 23 is defined in the inclined perimeter surface 21 of the striking plate 20, and an annular flange 15 is formed on the inclined perimeter surface 12 of the body 10. The annular flange 15 is received in the annular groove 23 to accurately positioning the striking plate 20 in the opening 11 of the body 10. The leveling of the striking plate 20 is assured.

While the principles of this invention have been disclosed in connection with specific embodiments, it should be understood by those skilled in the art that these descriptions are not intended to limit the scope of the invention, and that any modification and variation without departing the spirit of the invention is intended to be covered by the scope of this invention defined only by the appended claims.

1. A method for manufacturing a golf club head, comprising:
providing a body having an opening delimited by an inclined surface;
providing a striking plate with an inclined surface;
engaging the inclined surface of the striking plate with the inclined surface of the body;
applying a force to the striking plate to tightly embed the striking plate in the opening of the body;
moving a rotating pin along an engaging area between the striking plate and the body to proceed with friction welding; and
surface finishing the engaging area between the striking plate and the body.

2. The method as claimed in claim 1, wherein the inclined surface delimiting the opening of the body tapers inward, and wherein the inclined surface of the striking plate tapers rearward.

3. The method as claimed in claim 1, wherein the inclined surface delimiting the opening of the body is one of planar and arcuate, and wherein the inclined surface of the striking plate is one of planar and arcuate.

4. The method as claimed in claim 1, wherein the inclined surface of the body has a height greater than a thickness of the striking plate.

5. The method as claimed in claim 1, wherein one of the inclined perimeter surface of the body and the inclined surface of the striking plate includes an annular groove, and wherein the other of the inclined surface of the body and the inclined surface of the striking plate includes an annular flange received in the annular groove, providing accurate positioning.

6. The method as claimed in claim 1, wherein the opening of the body further includes a shoulder.

7. The method as claimed in claim 1, further including an intermedia layer between the inclined surface of the body and the inclined surface of the striking plate.

8. The method as claimed in claim 7, wherein the intermedia layer is formed from a material selected from the group consisting of niobium, chromium, aluminum, copper, iron, zirconium, titanium, vanadium, tantalum, silver, nickel, tungsten, and alloys thereof.

9. The method as claimed in claim 7, wherein the intermedia layer is formed on one of the inclined surface of the body and the inclined surface of the striking plate by means of one of electroplating and coating.

10. The method as claimed in claim 1, wherein the inclined surface of the body is formed on an inner perimeter surface delimiting the opening, and wherein the inclined surface of the striking plate is formed on an inner perimeter surface of the striking plate.

11. A friction welding structure for a golf club head, comprising:
a body having an opening in a front side thereof, the opening being delimited by an inclined perimeter surface; and
a striking plate having a front face for striking a golf ball, the striking plate further including an inclined perimeter surface.

12. The friction welding structure for a golf club head as claimed in claim 11, wherein the inclined perimeter surface delimiting the opening of the body tapers inward, and wherein the inclined perimeter surface of the striking plate tapers rearward.

13. The friction welding structure for a golf club head as claimed in claim 11, wherein the inclined perimeter surface is one of planar and arcuate.

14. The friction welding structure for a golf club head as claimed in claim 11, wherein the inclined perimeter surface of the body has a height greater than a thickness of the striking plate.

15. The friction welding structure for a golf club head as claimed in claim 11, wherein one of the inclined perimeter surface of the body and the inclined perimeter surface of the striking plate includes an annular groove, and wherein the other of the inclined perimeter surface of the body and the inclined perimeter surface of the striking plate includes an annular flange received in the annular groove, providing accurate positioning.

16. The friction welding structure for a golf club head as claimed in claim 11, wherein the opening of the body further includes a shoulder.

17. The friction welding structure for a golf club head as claimed in claim 11, further including an intermedia layer between the inclined perimeter surface of the body and the inclined perimeter surface of the striking plate.

18. The friction welding structure for a golf club head as claimed in claim 17, wherein the intermedia layer is formed from a material selected from the group consisting of niobium, chromium, aluminum, copper, iron, zirconium, titanium, vanadium, tantalum, silver, nickel, tungsten, and alloys thereof.

19. The friction welding structure for a golf club head as claimed in claim 17, wherein the intermedia layer is formed on the inclined perimeter surface of the body by means of one of electroplating and coating.

20. The friction welding structure for a golf club head as claimed in claim 17, wherein the intermedia layer is formed on the inclined perimeter surface of the striking plate by means of one of electroplating and coating.
